(19) United States
(12) Patent Application Publication
(10) Pub. No.: US 2003/0158943 A1
(43) Pub. Date: Aug. 21, 2003

(54) Real time data retrieving method of off-land transportation

(76) Inventors: Bong Kyum Kim, Seoul (KR); Daewoo Kim, Torrance, CA (US)

Correspondence Address: PARK & SUTTON LLP, 3255 WILSHIRE BLVD, SUITE 1110, LOS ANGELES, CA, 90010, US

(21) Appl. No.: 10/059,992

(22) Filed: Jan. 28, 2002

(51) Int. Cl. G06F 15/16

(52) U.S. Cl. 709/227; 709/217; 340/945

(57) ABSTRACT

A real time data retrieving method comprises enabling a control system in an off-land transportation to dial a ground call center, activating a data link between the control system and a satellite to allow the satellite to relay an operation information of the transportation to a ground gateway, transmitting the operation information from the ground gateway to a ground data storage which allows a network access thereto, and enabling a data subscriber connected to the call center to real time retrieve the off-land transportation from the data storage.

### BACKGROUND OF INVENTION

The present invention relates to a data retrieval method. More particularly, the invention relates to a method of retrieving from the ground an operation data of an off-land transportation such as an aircraft and a watercraft data, by enabling a telephone user or an internet user to real time monitor what happens, for example, within a specific aircraft.

When there occurs an aircraft accident such as a blast in the air and crash into the ground, the accident investigation is usually focused on collection of so called black box since it would in most cases tell how the accident has taken place, and same with a watercraft. As is often the case, when the aircraft blasted over the sea, it becomes much difficult to collect the black box, thus leaving the blast behind as a mystery.

A demand in the industry is to safely back up the data of the black box of the doomed aircraft so as to easily track down the reason of an aircraft accident even prior to discovering the black box or in case of irreparably damage or permanent loss of the black box. Another demand is to enable an individual on the ground to real time view and listen to what is going on in the aircraft where his or her beloved one is aboard.

### SUMMARY OF THE INVENTION

Accordingly, it is an object of the present invention to provide a method of real time retrieving from the ground an off-land transportation such as an aircraft, so that an individual on the ground can easily monitor the happenings, for example, in a specific aircraft using a public telephone network or internet.

Another object of the invention is to secure a safer passenger transportation of an aircraft in the air, a watercraft on the sea or a submarine under the water by allowing safety personnel on the ground to take a better action in case of a hijacking, a terror threat or other operation accidents.

To achieve the above-described objects, the real time data retrieving method according to the present invention comprises a first step of enabling a data control system in an off-land transportation to dial a ground call center when an engine of the off-land transportation starts. The data control system controls an operation information of the off-land transportation. A second step is activating a data link between the data control system and a communication satellite to allow the satellite to relay the operation information to a ground gateway. A third step is transmitting the operation information from the ground gateway to a ground data storage which allows a network access thereto, wherein the ground call center becomes accessed to the data storage. A fourth step is enabling a data subscriber connected to the call center to real time retrieve the off-land transportation from the data storage.

In an embodiment, a real time data retrieving method comprises a first step of a crew aboard an off-land transportation enabling a data control system in the transportation to dial a ground call center when an engine of the off-land transportation starts wherein the data control system controls an operation information of the off-land transportation, a second step of the crew activating a data link between the data control system and a communication satellite to allow the satellite to relay the operation information to a ground gateway, a third step of the ground gateway transmitting the operation information to a data storage which allows a network access thereto wherein the ground call center becomes accessed to the data storage, and a fourth step of the call center authorizing a data subscriber a wireless access to the data storage to enable the data subscriber to real time retrieve the operation information from the data storage.

The data control system is powered by the off-land transportation engine, whereby the data control system stops a data transmission therefrom at the occurrence of an unexpected engine stoppage so as to prevent a data overwriting on a storage disk sector which otherwise could be overlapped thereon by a futile data generated after the engine stoppage. The operation information comprises a crew voice recording, a passenger voice recording, and an operation data recording wherein the operation data recording includes parameters encompassing a speed, a height, a location and an estimated arrival time of the transportation within a time frame. The operation information is real time stored in the data storage and selectably partitioned in a voice-only stream, a voice-image stream and an aviation data stream. The off-land transportation is one of an aircraft, a spacecraft, a watercraft, and a submarine.

In another embodiment, a method of real time retrieving from the ground an operation information of an aircraft according to the present invention comprises a first step of a crew aboard the aircraft enabling a data control system in the aircraft to dial a ground call center when an engine of the aircraft starts wherein the data control system controls the operation information, a second step of the crew activating a data link between the data control system and a communication satellite to allow the satellite to relay the operation information to a ground gateway, a third step of the ground gateway transmitting the operation information to a data storage which allows a network access thereto, wherein the ground call center becomes accessed to the data storage, and a fourth step of a remote web server real time retrieving the operation information from the data storage, wherein the remote web server is internet-accessible.

For a better performance, the remote web server enables an internet user connected thereto to generate a precautionary call which may help prevent a hijacking and a terror threat in the aircraft. The remote web server enables an internet user to access value added services therethrough, wherein the value added services include an online shopping, an online chatting, an online game, a real time stock trading, and a real time news service. The remote web server is connected to the ground call center.

An advantage of the present invention is to enable an individual on the ground to easily monitor what happens, for example, in a specific aircraft where his or her beloved ones are aboard by utilizing a public telephone network or internet. Another advantage is to substantially decrease possibility of accident probabilities in an off-land transportation such as an aircraft, a watercraft, and a submarine by allowing an individual on the ground to real time double check via a subscription network the safety of passengers and crew aboard the off-land transportation. Further, the real time data retrieval method enables the passengers and crew aboard with a communication tool such as an internet-ready cellular phone and laptop computer to feed back an alternative real time operation information in the off-land transportation so as produce an early warning alert against a in-flight terror, hijacking and other possible accidents.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a block diagram showing a mechanism of a real time data retrieving method for an off-land transportation according to the present invention;

FIG. 2 is a block diagram detailing the mechanism shown in FIG. 1;

FIG. 3 is a flow chart showing steps of the real time data retrieving method for an aircraft according to an embodiment of the present invention; and

FIG. 4 is a flow chart showing steps of the real time data retrieving method for a watercraft according to another embodiment of the present invention.

### DETAILED DESCRIPTION OF THE PREFERRED EMBODIMENTS

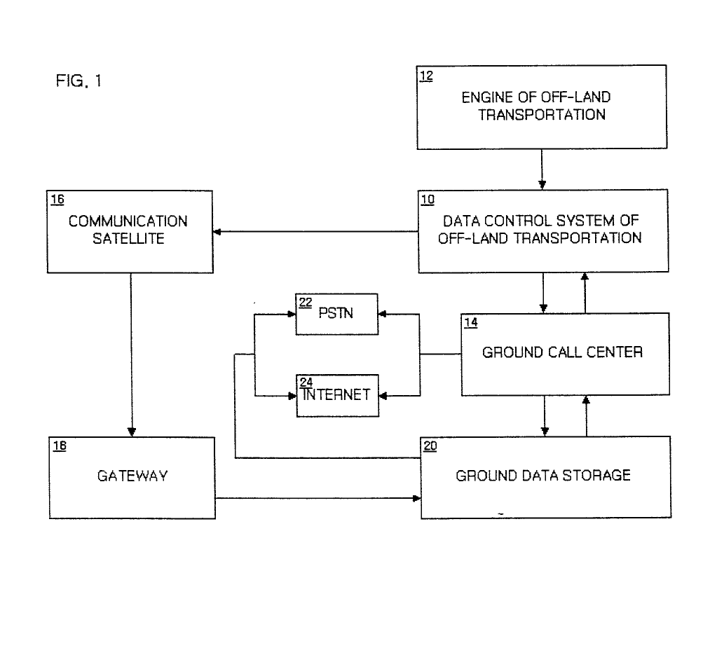

FIG. 1 shows a brief overview of the real time data retrieval of an off-land transportation from the ground. As shown therein, a data control system 10 is provided in an off-land transportation or an off-land vehicle such as an aircraft, spacecraft, a watercraft and a submarine. An engine 12 of the off-land vehicle (not shown) powers the data control system 10 installed therein. A battery backup system may be also applied to the data control system 10 for a system backup at an emergency. The data control system 10 allows crew aboard the off-land vehicle to manage and control each part and function of the off-land vehicle.

When the engine 12 of, for example, an aircraft starts on a ground stop (not shown), the data control system 10 is programmed such that it makes a dialing to a ground call center to become connected to a network or to stay online in accordance with a command of a qualified crew member in a cockpit. A ground call center 14 is stationed on the ground and wirelessly connected to the aircraft. That is, the data control system 10 of the aircraft becomes hooked on to the ground call center 14 either automatically at the engine start or in accordance with a command of the qualified crew member. The ground call center 14 may be independent of a control tower (not shown) that controls and manages landing and takeoff of aircraft on and from a designated ground spot, that is, an airport.

In order to extend a communication limitation for the off-land transportation, a communication satellite 16 may be utilized to maximize communicability of, for example, the aircraft with a ground gateway 18. Selectively, a plurality of satellites forming a satellite constellation may serve as a link of an efficient communication between the aircraft and the ground. The gateway 18 may be stationed on the ground to modulate signals from the satellite 16 to a ground data storage 20. The ground data storage 20 is connected to a PSTN 22 (public switching telephone network) and an internet 24 so that the PSTN and internet can retrieve data generated by the data control system 10 of the off-land transportation via the ground data storage 20. Meanwhile, it is preferred that the ground call center 14 be also connected to the PSTN 22, internet 24 and the ground data storage 20.

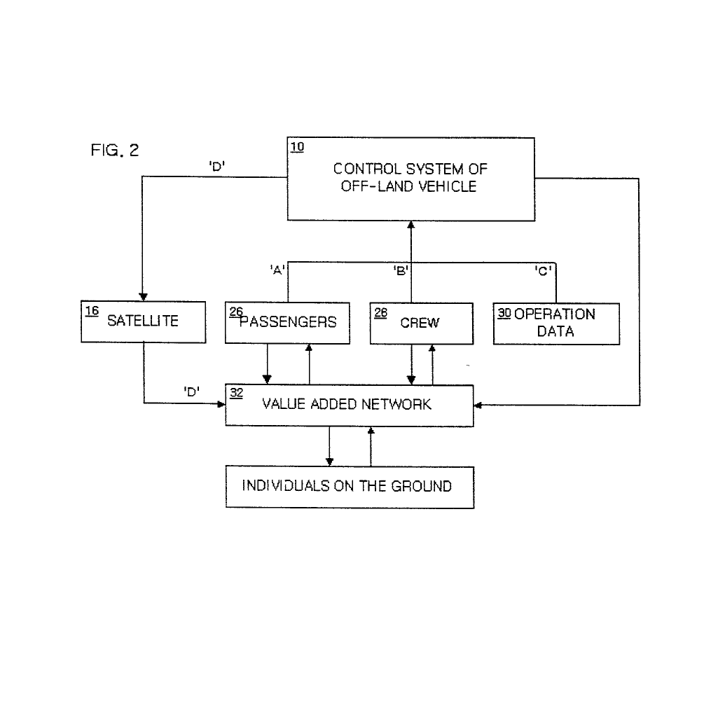

As shown in FIG. 2, the data control system 10 stores therein a passenger voice recording A from passengers 26, a crew voice recording B from crew members 28, and a mechanical recording C from an operation data 30. Here, the passenger voice recording A is a data recorded in a passenger cabin (not shown) of the off-land vehicle, the crew voice recording B is a data recorded in a cockpit in case of an aircraft and in a pilot house in a watercraft such as a liner, and the mechanical recording C is an operation data of the off-land transportation. The mechanical recording C includes parameters such as heights, speed, location, arrival time and others.

In turn, the data control system 10 that has received therein the passenger voice recording A, the crew voice recording B, and the mechanical recording C transmits an operation information D integrating all the three recordings A, B, C to the satellite 16. A value added network 32 on the ground receives the operation information D from the data control system 10 of the off-land transportation via the satellite 16 so that individuals subscribing the value added network 32 on the ground can real time retrieve the operation information D. On the other hand, the passengers 26 and crew 28 aboard the off-land transportation can also real time retrieve the off-land transportation of their own riding through the value added network 32 via, for example, a laptop computer connectable to the value added network 32. The value added network 32 may include the PSTN 22 and the internet 24. Selectively, the control system 10 may be directly, connected to the value added network 32 without requiring the satellite 16 using the known art.

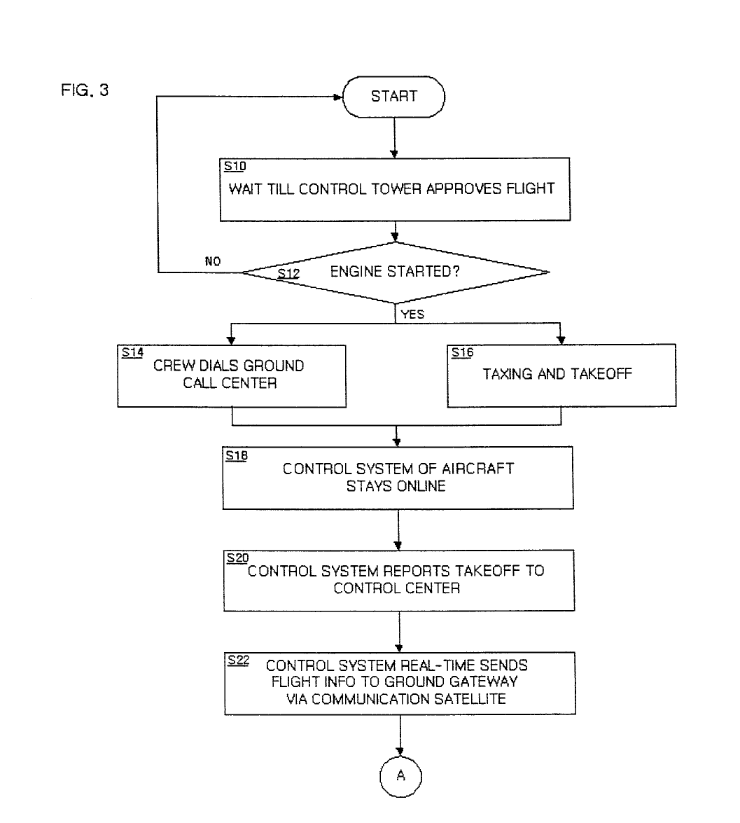

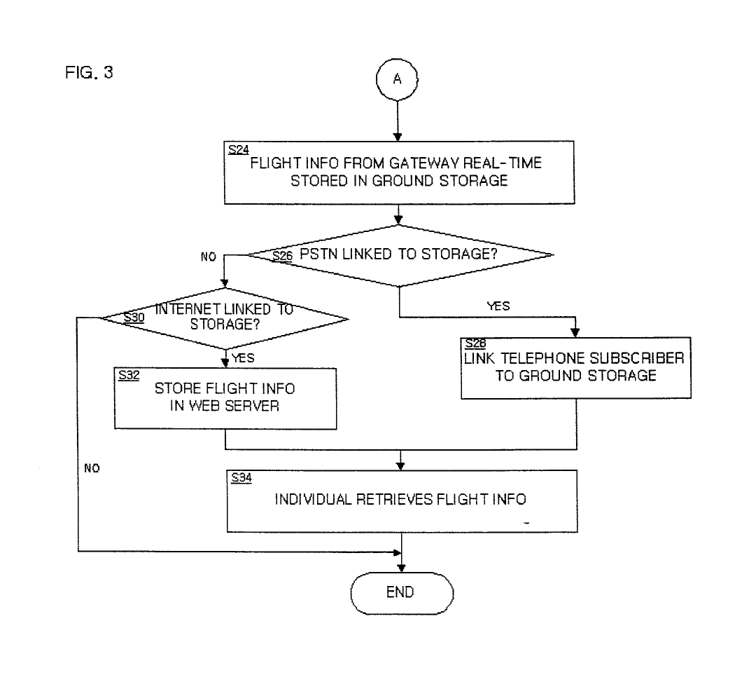

FIG. 3 shows a flow chart showing an embodiment applying an aircraft to implement the real time data retrieving method of an off-land transportation from the ground according to the present invention. As shown therein, once the ready-fly aircraft obtains flight approval from a control tower (S10) the engine 12 of the aircraft is started (S12). At the start of the engine the crew aboard the flight dials a ground call center (S14) while the aircraft proceeds taxing and takeoff from the ground (S16) so that the data control system 10 of the aircraft stays connected to the ground call center (S18). The control system subsequently reports the takeoff to the control tower either automatically or manually (S20). Once the aircraft is taken off from the ground, the control system of the aircraft starts real time sending flight information to the ground gateway 18 via the communication satellite (S22).

Here, the flight information includes a cockpit voice recording, a passenger voice recording, and an operation data. The cockpit voice recording is implemented in the cockpit to record sounds and voices being produced within the cockpit where pilots and copilots manage and control the aviation of the flight. The passenger voice recording is implemented within a passenger cabin and may include voice information of other crew members in the passenger cabin. The operation data includes parameters such as speed, height, a relative location over the ground, expected time to destination and other mechanical data.

The ground gateway 18 redirects the flight information from the communication satellite to the ground data storage so that the flight information becomes real time stored in the ground data storage (S24). If the data storage is linked the public switching telephone network or PSTN (S26) that allow its service subscribers to retrieve data, the telephone service subscribers are authorized to access the ground storage via the telephone network (S28). Either wired or wireless services may be applied to the data retrieval through the PSTN for the flight information retrieval so that individual service subscribers are allowed to retrieve the flight information (S34).

If the data storage is accessible to internet (S30) the flight information is stored in a web server that allows a world wide web access or an internet access. Eventually, individuals on the ground who either subscribes the internet service or a telephone service can easily retrieve the cockpit voice recording and passenger voice recording of the aircraft where their beloved ones are aboard on the base of real time access.

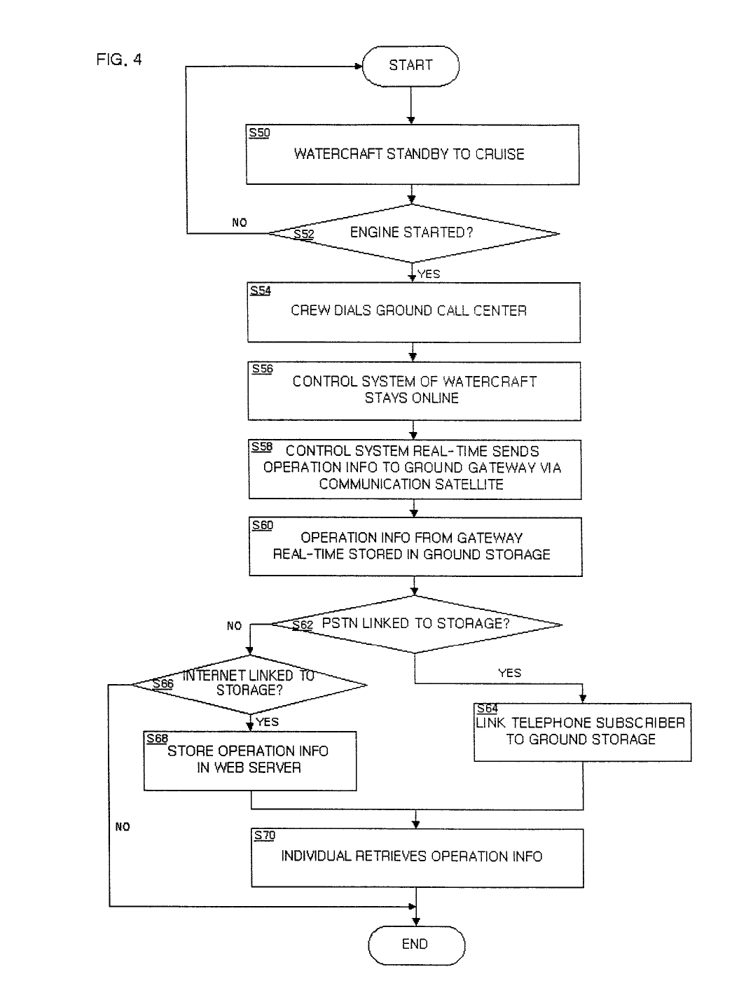

FIG. 4 shows another embodiment applying a watercraft such as a liner to implement the real time data retrieving method according to the present invention. As shown therein, once a watercraft is ready to cruse (S50) and an engine of the watercraft is started (S52), a ground call center becomes connected to the watercraft by crew dialing (S54) and a control system of the watercraft stays online with the ground call center (S56). The data control system real time sends operation information to a ground gateway via a communication satellite (S58) and the ground gateway redirects the operation information from the satellite to a ground data storage on real time basis (S60). Here, the operation information of the watercraft includes a crew voice recording, if any, a passenger voice recording, and a mechanical data. The crew voice recording is implemented in a steering house of the watercraft to record sounds and voices being produced within the house where captain and other crew member manage and control the cruising of the watercraft. The passenger voice recording, if applied, is implemented within a passenger cabin and may include voice information of other crew members in the passenger cabin. The mechanical data includes parameters such as speed, height, a relative location over the ground, expected time to destination and other mechanical data. The other steps S62 to S70 in FIG. 4 is identical to those in FIG. 3.

As shown in the attached drawings FIGS. 1 through 4, the real time data retrieving method according to a first embodiment of the present invention is incorporated to comprise a first to fourth step. The first step is enabling a data control system 10 in an off-land transportation to dial a ground call center 14 when an engine 12 of the off-land transportation starts. The data control system 10 controls an operation information of the off-land transportation. The second step is activating a data link between the data control system and a communication satellite 16 to allow the satellite 16 to relay the operation information to a ground gateway 18. The third step is transmitting the operation information from the ground gateway 18 to a ground data storage 20 which allows a network access thereto. The ground call center becomes accessed to the data storage 20. The fourth step is enabling a data subscriber connected to the call center to real time retrieve the off-land transportation from the data storage 20.

The data control system 10 is powered by the off-land transportation engine 12 so that the data control system stops a data transmission therefrom at the occurrence of an unexpected engine stoppage, thereby preventing a data overwriting on a storage disk sector (not shown) which otherwise could be overlapped thereon by a futile data generated after the engine stoppage. In a preferred version, the operation information comprises a crew voice recording, a passenger voice recording, and an operation data recording, wherein the operation data recording includes parameters encompassing a speed, a height, a location and an estimated arrival time of the transportation within a time frame. Also, the operation information is real time stored in the data storage 20 and selectably partitioned in a voice-only stream, a voice-image stream and an aviation data stream. The data subscriber may be accessed to the ground call center by either a wired telephone or a wired videophone. The off-land transportation may be one selected from an aircraft, spacecraft, a watercraft, a submarine and other off-land vehicles that are operable off the ground.

In another embodiment, a real time data retrieving method comprises first to fourth steps where the first step is allowing a crew aboard an off-land transportation to enable a data control system 10 in the transportation to dial a ground call center when an engine of the off-land transportation starts where the data control system 10 controls an operation information of the off-land transportation. The second step is such that the crew activates a data link between the data control system 10 and a communication satellite 16 to allow the satellite to relay the operation information to a ground gateway 18. The third step is allowing the ground gateway 18 to transmit the operation information to a data storage 20 which allows a network access thereto. Here, the ground call center 20 becomes accessed to the data storage. The fourth step is allowing the call center to authorize a data subscriber a wireless access to the data storage to enable the data subscriber to real time retrieve the operation information from the data storage. The operation information comprises a crew voice recording, a passenger voice recording, and an operation data recording in which the operation data recording includes parameters encompassing a speed, a height, a location and an estimated arrival time of the transportation within a time frame.

For a better performance, the method of real time retrieving from the ground an operation information of an aircraft comprises first to fifth steps in which the first step is allowing a crew aboard the aircraft to enable a data control system 10 in the aircraft to dial a ground call center 14 when an engine 12 of the aircraft starts in which the data control system 10 controls the operation information. The second step is allowing the crew to activate a data link between the data control system and a communication satellite to allow the satellite 16 to relay the operation information to a ground gateway 18. The third step is enabling the ground gateway to transmit the operation information to a data storage 20 which allows a network access thereto. Here, the ground call center 20 becomes accessed to the data storage 20. The fourth step is allowing a remote web server to real time retrieve the operation information from the data storage 20. The remote web server is internet-accessible. The fifth step is allowing the remote web server to enable an internet user connected thereto to generate a precautionary call which may help prevent a hijacking and a terror threat in the aircraft.

The remote web server enables an internet user to access value added services therethrough, and the value added services include an online shopping, an online chatting, an online game, a real time stock trading, and a real time news service. The operation information comprises a cockpit voice recording, an aviation data recording, and a passenger cabin voice recording. Here, the aviation data recording may include parameters encompassing a speed, a height, a location and an arrival time of the aircraft within a time frame. Selectively, the remote web server is connected to the ground call center so as to allow either the telephone subscriber to retrieve the flight information via the web server or the internet user to retrieve the flight information via the public switching telephone network.

As discussed above, an advantage of the present invention is to enable an individual on the ground to easily monitor what happens, for example, in a specific aircraft where his or her beloved ones are aboard by utilizing a public telephone network or internet. A further advantage is to substantially decrease possibility of accident probabilities in an off-land transportation such as an aircraft, a watercraft, and a submarine by allowing an individual on the ground to real time double check via a subscription network the safety of passengers and crew aboard the off-land transportation. In addition, the real time data retrieval method enables the passengers and crew aboard with a communication tool such as an internet-ready cellular phone and laptop computer to feed back an alternative real time operation information in the off-land transportation so as produce an early warning alert against a in-flight terror, hijacking and other possible accidents.

Although the invention has been described in considerable detail with reference to certain preferred versions thereof, other versions are possible by converting the aforementioned construction. Therefore, the scope of the invention shall not be limited by the specification specified above and the appended claims.

What is claimed is:

1. A real time data retrieving method, comprising the steps of:
a) enabling a data control system in an off-land transportation to dial a ground call center when an engine of the off-land transportation starts, wherein the data control system controls an operation information of the off-land transportation;
b) activating a data link between the data control system and a communication satellite to allow the satellite to relay the operation information to a ground gateway;
c) transmitting the operation information from the ground gateway to a ground data storage which allows a network access thereto, wherein the ground call center becomes accessed to the data storage; and
d) enabling a data subscriber connected to the call center to real time retrieve the off-land transportation from the data storage.

2. The method of claim 1 wherein the data control system is powered by the off-land transportation engine, whereby the data control system stops a data transmission therefrom at the occurrence of an unexpected engine stoppage so as to prevent a data overwriting on a storage disk sector which otherwise could be overlapped thereon by a futile data generated after the engine stoppage.

3. The method of claim 1 wherein the operation information comprises a crew voice recording and an operation data recording, wherein the operation data recording includes parameters encompassing a speed, a height, a location and an estimated arrival time of the transportation within a time frame.

4. The method of claim 1 wherein the operation information comprises a crew voice recording, a passenger voice recording, and an operation data recording, wherein the operation data recording includes parameters encompassing a speed, a height, a location and an estimated arrival time of the transportation within a time frame.

5. The method of claim 1 wherein the operation information is real time stored in the data storage and selectably partitioned in a voice-only stream, a voice-image stream and an aviation data stream.

6. The method of claim 1 wherein the data subscriber is accessed to the ground call center by either a wired telephone or a wired videophone.

7. The method of claim 1 wherein the off-land transportation is an aircraft.

8. The method of claim 1 wherein the off-land transportation is a spacecraft

9. The method of claim 1 wherein the off-land transportation is a watercraft.

10. The method of claim 1 wherein the off-land transportation is a submarine.

11. A real time data retrieving method, comprising the steps of:
a) a crew aboard an off-land transportation enabling a data control system in the transportation to dial a ground call center when an engine of the off-land transportation starts, wherein the data control system controls an operation information of the off-land transportation;
b) the crew activating a data link between the data control system and a communication satellite to allow the satellite to relay the operation information to a ground gateway;
c) the ground gateway transmitting the operation information to a data storage which allows a network access thereto, wherein the ground call center becomes accessed to the data storage; and
d) the call center authorizing a data subscriber a wireless access to the data storage to enable the data subscriber to real time retrieve the operation information from the data storage.

12. The method of claim 11 wherein the data control system is powered by the off-land transportation engine, whereby the data control system stops a data transmission therefrom at the occurrence of an unexpected engine stoppage so as to prevent a data overwriting on a storage disk sector which otherwise could be overlapped thereon by a futile data generated after the engine stoppage.

13. The method of claim 11 wherein the operation information comprises a crew voice recording and an operation data recording, wherein the operation data recording includes parameters encompassing a speed, a height, a location and an estimated arrival time of the transportation within a time frame.

14. The method of claim 11 wherein the operation information comprises a crew voice recording, a passenger voice recording, and an operation data recording, wherein the operation data recording includes parameters encompassing a speed, a height, a location and an estimated arrival time of the transportation within a time frame.

15. The method of claim 11 wherein the operation information is real time stored in the data storage and selectably partitioned in a voice-only stream, a voice-image stream and an aviation data stream.

16. The method of claim 11 wherein the off-land transportation is an aircraft.

17. The method of claim 11 wherein the off-land transportation is a spacecraft

18. The method of claim 11 wherein the off-land transportation is a watercraft.

19. The method of claim 11 wherein the off-land transportation is a submarine.

20. A method of real time retrieving from the ground an operation information of an aircraft, comprising the steps of:
a) a crew aboard the aircraft enabling a data control system in the aircraft to dial a ground call center when an engine of the aircraft starts, wherein the data control system controls the operation information;
b) the crew activating a data link between the data control system and a communication satellite to allow the satellite to relay the operation information to a ground gateway;
c) the ground gateway transmitting the operation information to a data storage which allows a network access thereto, wherein the ground call center becomes accessed to the data storage; and
d) a remote web server real time retrieving the operation information from the data storage, wherein the remote web server is internet-accessible.

21. The method of claim 20 further comprising, after the step d), the remote web server enabling an internet user connected thereto to generate a precautionary call which may help prevent a hijacking and a terror threat in the aircraft.

22. The method of claim 20 wherein the remote web server enables an internet user to access value added services therethrough, wherein the value added services include an online shopping, an online chatting, an online game, a real time stock trading, and a real time news service.

23. The method of claim 20 wherein the data control system is powered by the aircraft engine, whereby the data control system stops a data transmission therefrom at the occurrence of an unexpected engine stoppage so as to prevent a data overwriting on a storage disk sector which otherwise could be overlapped thereon by a futile data generated after the engine stoppage.

24. The method of claim 20 wherein the operation information comprises a cockpit voice recording and an aviation data recording, wherein the aviation data recording includes parameters encompassing a speed, a height, a location and an arrival time of the aircraft within a time frame.

25. The method of claim 20 wherein the operation information comprises a cockpit voice recording, an aviation data recording, and a passenger cabin voice recording, wherein the aviation data recording includes parameters encompassing a speed, a height, a location and an arrival time of the aircraft within a time frame.

26. The method of claim 20 wherein the operation information is real time stored in the data storage and selectably partitioned in a voice-only stream, a voice-image stream and an aviation data stream.

27. The method of claim 20 wherein the remote web server is connected to the ground call center.
